(19) United States
(12) Patent Application Publication
(10) Pub. No.: US 2010/0175897 A1
(43) Pub. Date: Jul. 15, 2010

(54) Self-sustaining compressed air foam system

(76) Inventor: Stephen Douglas Crump, Chico, CA (US)

Correspondence Address: Stephen Douglas Crump, 615 Tandy Court, Chico, CA, 95973, US

(21) Appl. No.: 12/653,650

(22) Filed: Dec. 16, 2009

Related U.S. Application Data
(60) Provisional application No. 61/144,173, filed on Jan. 13, 2009.

(51) Int. Cl. A62C 35/68

(52) U.S. Cl. 169/14

(57) ABSTRACT

A Self-Sustaining Compressed Air Foam System that utilizes a vacuum proportioning blending console, delivering pre-determined amounts of fire pre-suppressant/suppressant foam concentrate with ratios from 0.01% to 6% and water when used in concert with a vacuum dispensing closure for tight head pails dispensing said foam concentrate that is plumbed to either an air operated pump or solar powered electric pump on the inlet side producing a pre-suppressant foam solution. A second blender/mixer/agitator conjoins an inert pressurized gas or air at the outlet of the pump variables to produce the finished pre-suppressant/suppressant foam product for various applications including structure protection in wild fire events. A special nozzle can be used as the applicator that reduces pressure/velocity of the finished foam to allow the user to work in confined areas and/or in areas that are normally out of reach of the foam stream projected.

This application is based on Provisional Application Ser. No. 61/144,173 filed on Jan. 13, 2009.

### FIELD OF THE INVENTION

This invention relates to sustainable foam fire protection equipment, in particular, an apparatus for generating and delivering pre-fire suppressant foam for use in fire protection.

Any discussion of prior art throughout the specification should in no way be considered as an admission that such prior art is widely known or forms part of common knowledge in the field.

Making a clear distinction between urban, rural and wildland fire protection responsibilities has been difficult in recent years due to California's rapid population growth and accompanying residential, commercial and industrial development in these diverse geographical settings. As the number of people and structures has grown and spread to areas of flammable vegetation with steeper topography, a fire protection problem of unprecedented magnitude has developed. California between 1984 to 1993 lost 75 people to wildfires and over 7000 structures were destroyed resulting in over 3 billion dollars in damage. And lives, property and natural resources lost to wildfire will continue to increase, paralleling this human migration. The values at risk, represented by people and property sharing the tinder-dry steep slopes of California's “Wildland/Urban Interface” (WUI) illustrates the most difficult, dynamic wildfire protection challenge in the world. With the exception of firefighting professionals (who are often spread to thin) and their equipment (which has difficulty navigating this particular terrain), there are few products available which can adequately protect structures in the path of a wildfire. Federal and State officials claim: “ultimately, property owners are responsible for their own fire protection”. The “Self-Sustaining Compressed Air Foam System” eliminates the product technology gap between the garden hose and the fire department.

It is estimated that 42 million structures are at risk to wildfire across the United States. 5 million structures are at risk in California alone. When wildfire breaks out in the WUI, pushed by high winds and extreme temperatures, available firefighting resources often spend their time saving lives and evacuating people, leaving the fire to burn unchecked until reinforcements arrive.

The fact that water is not the perfect tool for extinguishing fire has long been acknowledged and discussed. It's a cumbersome fluid and it is costly to install water mains large enough for required flow. The installation and maintenance of fire hydrants, procurement and required care of fire engines and all the accompanying apparatus, make water an increasingly valuable natural resource and a very expensive extinguishing agent.

The use of foam additives to fight fire dates back to England in the late 1800's. The British Navy experimented with foam and compressed air in the 1930's. And The U.S. Navy was using compressed air foam (CAF) against flammable liquid fires in the 1940's. In the 1960's do-it-yourself car wash businesses were using compressed air foam systems with low pressure and small diameter hoses and nozzles.

In the mid 1970's the Texas Forest Service developed a water expansion system known as the “Texas Snow Job’, and this pioneering “Class A” compressed air foam system used a pine soap derivative as a foaming agent. By the 1980's, research by the U.S. Bureau of Land Management led to modern design features of rotary air compressors, centrifugal pumps and direct injection foam proportioning systems. The basic premise of compressed air foam technology is the addition of a minute percentage of a soap-like concentrate to water as it runs through a standard pumping system, and then to inject compressed air as the water discharges from the pump. The soap-like concentrate reduces the surface tension of the water, then the air disturbs the solution to create a bubble structure which is an effective barrier against flying embers and flames. CAF systems received national attention in 1988 during the Yellowstone Park wildfires when an applied blanket of compressed air foam successfully protected Old Faithful Lodge.

Today, common design features of CAFS are targeted for the professionally trained firefighter. Those systems require training and maintenance, as well as utilizing diverse foam concentrates for several different fire fighting applications (i.e., wildland vs. liquid fuel fires). Foam from CAFS can also be used as a carrier for both agricultural and hazardous material applications: this means that a pesticide or decontamination agent can be added to the mix of water and foam concentrate to take advantage of foams characteristic to cling to what it is applied to rather than running off as water would. These types of foam applications require very different proportioning rates of water and foam concentrate, and necessitate the need for trained and qualified operators. Even CAFS designed exclusively for wildland fires require training to operate correctly. Moreover, the cost of operating a professionally designed CAF is high. Internal combustion engines running pumps and compressors require fuel and maintenance and discharge large quantities of water very quickly. And the amount of foam concentrate needed is directly proportional to the gallons per minute discharge rate of these systems. Foam concentrate is very expensive. Professional CAFS often run at the rate of 175 gallons per minute (gpm) or more. The Hale HPX 200 is an example of an average professionally designed CAF system with a gpm rate as high as 300 gallons. To produce a structure protection quality foam would require 2.4 gallons per minute of foam concentrate, which would cost nearly 27 dollars per minute to produce foam. Consequently, firefighters use their CAFS on the low end of the proportioning scale (0.2-0.3%), rather than the 0.6 to 0.8% proportioning rate required for long-term structure protection.

Conversely, CAF systems designed with very low (5-20) gpm discharge rates are pre-mixed pressurized vessels that are limited in size and haven't the capacity to protect the average size structure in the WUI. American Fire and Tri-Max are two companies with this design and it is my belief they work on the principle of Cummins' U.S. Pat. No. 4,318,433 and the principle of an ejector tube and aeration/mixing chamber with foam discharged and propelled by an attached compressed air cylinder. They produce a quality foam product intended for immediate fire suppression or the protection of a very limited area in size and, are designed for professionals.

Another company, Intelagard, designed a backpack system U.S. Pat. No. 5,623,995 (Smagac) that required pouring foam concentrate into a tank of water. The two fluids then needed to be stirred for uniformity, and the system could subsequently be activated by the opening of several valves. Intelagard's current design U.S. Pat. No. 6,155,351 (Breedlove, Smagac) appears to have a metering pump attached to a separate foam concentrate tank capable of pumping specific proportioned amounts of concentrate into a water stream to produce a wide spectrum of finished foam types. However, it should be noted that there appears to be an error in that patent's description of that specific component. At one point, under the heading of “Agitation Apparatus” U.S. Pat. No. 6,155,351; column 9, lines 47, 49, 53 the component is referred to as an “agitation apparatus” 118, while at another site in the patent under the heading, “Source of Foam Fluid”; column 6, lines 39, 62 the same component is referred to as a “metering pump” 118. But regardless of that error in Intelagard's patent language, the use of a metering pump is unnecessary and wasteful. The problem with a metering pump is that it uses stored air energy, a needless process if not relying on compressor air to operate the metering pump(s). Property owners untrained in the art of pre-fire suppression equipment need the simplest and most efficient use of stored air energy when engaging a wildfire with a self-contained CAFS.

Venturi type proportioners utilize another engineering principle common in the proportioning of foam concentrate to water in compressed air foam systems. These types of systems offer a mechanical means for adjusting proportioning ratios and are geared to the fire fighting professional as they require training and understanding of the fluid requirements for fighting fire. Teske demonstrates an adjustable venture type in U.S. Pat. No. 5,255,747, as does Kroll in U.S. Pat. No. 4,474,680.

### BRIEF SUMMARY OF THE INVENTION

The object of the present invention overcomes the complexities associated with prior art. The present invention eliminates the need for an extra tank for foam concentrate or other amendments. The present invention also eliminates the need for pre-mixing a water/foam concentrate solution with the simple addition of a vacuum-dispensing-closure for tight head pails.

Another object of the present invention eliminates the need for individual (separate) components that proportion and blend foam concentrate within a water stream. The present invention accomplishes that task with the addition of a vacuum-proportioning-blending-console.

Another object of the present invention is to eliminate the need for a self-contained compressed air foam system that either (1) depends solely on a pre-mixed, pressurized vessel; or (2) relies on a fossil fuel run engine to operate a pump required for drawing fluids necessary for producing foam solutions.

Another object of the present invention is to eliminate waste, splash-back and the potential for over application of the foam blanket without having to reduce system pressure when relying on a large diameter single bored nozzle and applying foam in close quarters.

The present invention delivers foam concentrate from the 5-gallon tight head pail which is received from the manufacturer. The pail's original cap is replaced with a new cap, comprised of a port (which is connected to a metering valve) and a vent to atmosphere. This allows the pail to be inverted and attached to a compressed air foam system. The inverted pail is then attached to the branch of a tee, a component of the vacuum-blending console. Upstream of the branch of the tee is a constrictive plate. The foam concentrate is introduced downstream of the constrictive plate, via the metering valve, through the branch (vacuum port) of the tee which is adjacent to the vena contracta, created by the constrictive plate. A pressurized air/inert gas operated pump, or solar powered transfer pump, draws the water-foam solution through the vacuum-blending console up through said pump(s) to the pump outlet. At this juncture, a pressurized air/inert gas insertion port is attached to propel the foam solution through an agitator where the foam solution is expanded to its finished foam state to exit at a nozzle.

This unique nozzle is designed to reduce the trajectory of a standard single bore nozzle to which it is attached and divide the stream into four separate streams. This novel construction maintains system-working pressure while eliminating product waste due to splash back and over application of the foam product. This allows the user to apply foam in close proximity to a structure's eaves, or in confined areas such as under decks or carports.

The intention of this invention is to practice sustainability. Therefore, a solar powered transfer pump with necessary photovoltaic panels, inverters, energy storage components and other electrical items can be substituted for the pressurized air operated pump. With the solar powered variant, stored air energy need only be used for inserting pressurized air agitating and propelling the foam solution at the pump outlet to the application nozzle.

In summary the structures and methods comprising the present invention eliminate a component of existing CAFS. The present invention also combines and simplifies the proportioning and blending processes/methods of producing pre-suppression foam, while reducing waste (over application) at the nozzle.

### BRIEF DESCRIPTION OF THE DRAWINGS

FIG. 1 illustrates in block diagram view the options of the present invention and the components that make up the embodiments.

FIG. 1a illustrates in block diagram view the components of the preferred embodiment.

FIG. 2 illustrates in block diagram a view of the present invention and the components that make up the optional embodiment.

FIG. 3 illustrates a perspective view of the control panel.

FIG. 4-5 illustrates a perspective view of a tight head pail with vacuum dispensing closure.

FIG. 6 illustrates an inside perspective and side view of the vacuum-dispensing closure.

FIG. 7 illustrates a perspective view of the vacuum-blender console.

FIG. 8 illustrates a perspective view of the pressurized-air injector/agitator apparatus.

FIG. 9 illustrates a side view perspective of the nozzle with large bore single stream shutoff adapter.

FIG. 10 illustrates a front view perspective of the nozzle.

FIG. 11 illustrates a perspective of a detachable handle for the nozzle.

### DETAILED DESCRIPTION OF THE INVENTION

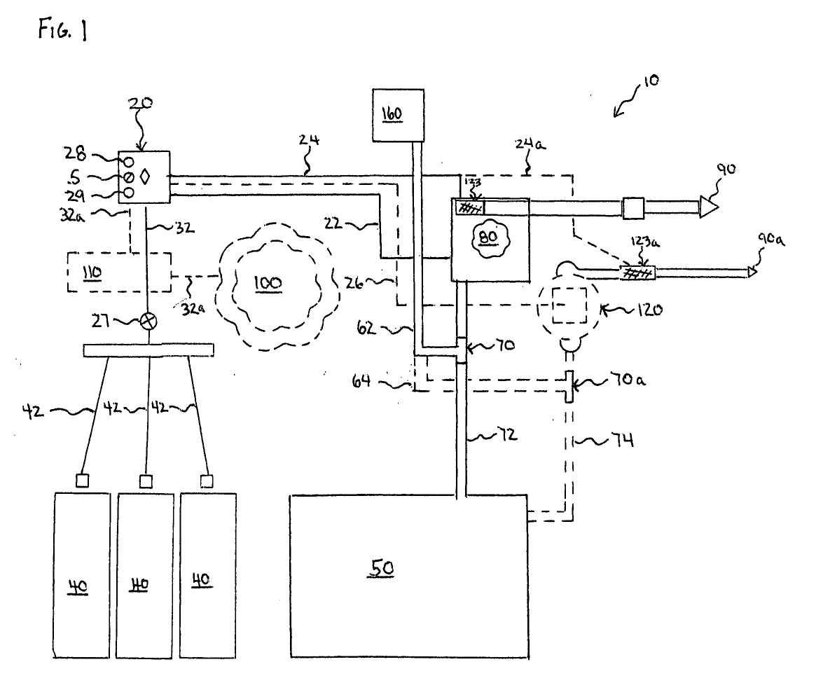

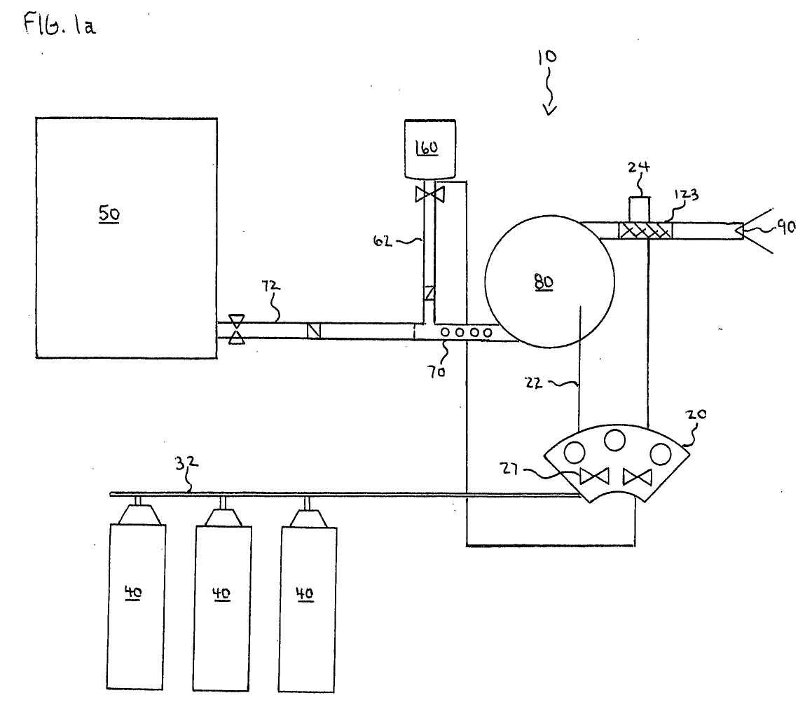

In FIG. 1, the self-sustaining compressed air foam system 10 illustrates in broken-lines an alternative to the preferred embodiment for the source of stored air energy 40 and stored solar energy 100. The implementation of each of these variations is subject to selection by one skilled in the art of the available technology to create a specific implementation of the system component.

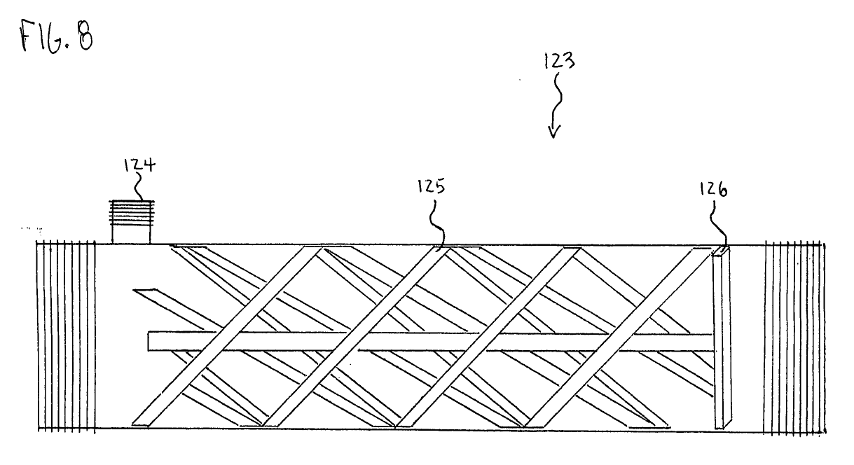

Overview: FIG. 1, the self-sustaining compressed air foam system comprises a source of stored energy 40,110 attached to a control panel 20 via energy supply lines 32,32a that attaches to a regulator 28,29 or switch S that operates a pump 80,120 and pressurized air injector/agitator 123,123a that is connected by a pipe, tube or hose 24, or wire 24a to said pump 80,120 that draws water via pipe, tube or hose 72,74 from a source of water or tank 50. A second foam concentrate container 160 intersects pipe 72,74 via a tube 62,64 at the branch of a tee 70,70a that conjoins the water line 72,74 with the foam concentrate dispensing tube 62,64 to form a water/foam concentrate solution that is drawn up through the pump 80,120 to pump outlet at the attached air injector/agitator 123,123a where foam solution is expanded by injected air via line 24,24a to air insertion port 124, FIG. 8, to form a foam and is set in motion via pipe or hose to exit at a nozzle 90, 90a that can be used to apply the finished foam as a pre-suppression foam for fire protection.

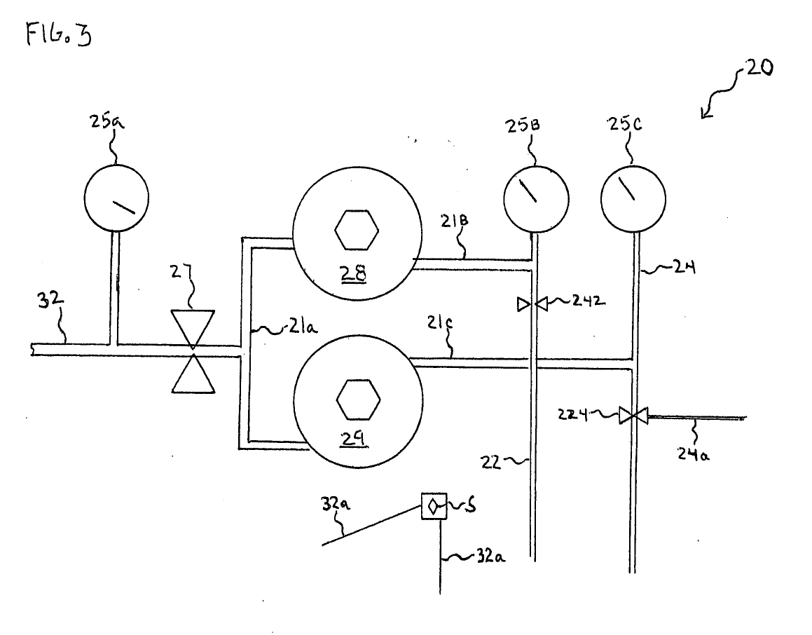

Control panel: Types and variations of stored energy 40, 110 are channeled to the control panel 20. In the preferred embodiment, FIG. 3 depicts supplied stored air energy through line 32 from compressed air cylinders 40 FIG. 1 or other inert gas such as nitrogen. Pressurized gas is prevented from activating the system with on/off valve 27 that is normally closed. System pressure is registered at gauge 25a. Open valve 27 and high pressure air is channeled to regulators 28, 29 via line 21a where system pressure is reduced to working pressure and exits at lines 21b, 21c and registers said working pressure on gauges 25b, 25c wherein said working pressure air is channeled to operate pump 80 via line 22 and to operate air insertion agitator 123 via line 24. The solar variance would require air supply line 22 to be closed and switch S closed on control panel 20 to supply stored electric energy via line 26 wherein air supply line 24 is shutoff with bypass valve 224 FIG. 3 to open line 24a and supply pressurized air to air insertion agitator 123a.

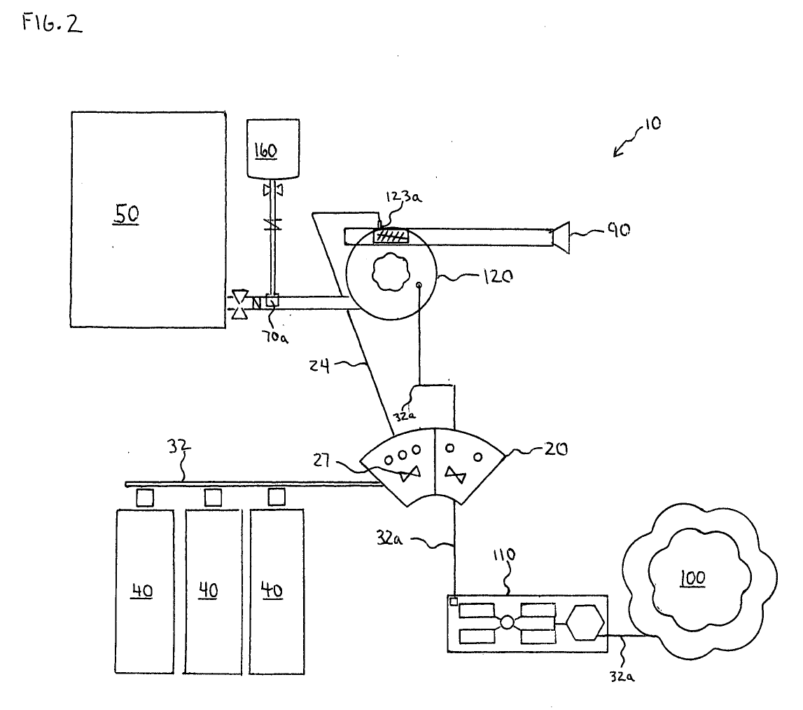

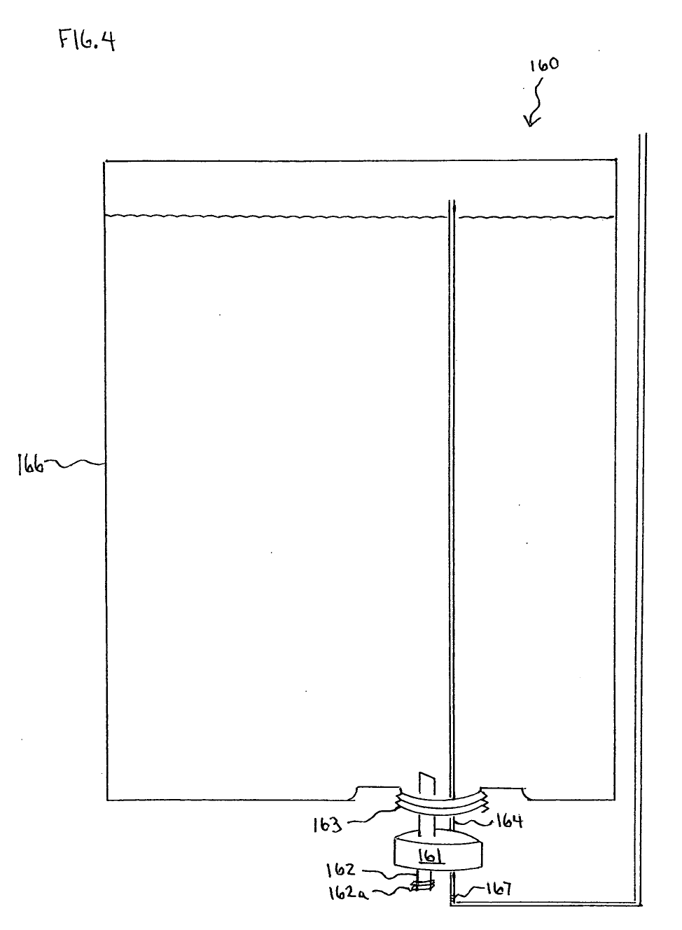

Process Components: Compressed air foam systems in general use one of two methods for producing a foam solution. One is to pre-mix water with a foam concentrate the other is to have a separate or second tank to that of water containing foam concentrate with a pump like device to inject the foam concentrate into a water stream. FIG. 4, of the preferred embodiment and its variant eliminates the need for the aforementioned methods. The nippled 162a and vented 164 vacuum dispensing closure 161 as depicted in relation to an inverted tight head pail 166 that contains a manufactured foam concentrate that dispenses said concentrate via metering valve (not shown) through tube 162 and attached at nipple 162a FIG. 1, that is attached to the branch of the vacuum blending console tee 70,70a that draws water from tank 50 when valve 27 FIG. 2 is opened to activate the air operated pump 80 FIG. 1. The solar variance would require air supply line 22 to be closed prior to opening valve 27 and a switch S closed on control panel to supply stored electric power 110 to pump 120 that would then draw foam concentrate from line 162 and water from line 74 simultaneously to be conjoined at the vacuum blending console tee 70a to form a blended foam solution prior to being drawn into pump 120 and exiting the air insertion agitator 123a where solution is expanded to form a finished foam and is propelled via pipe or hose to exit at a nozzle 90a that can be used to apply finished foam as a pre-suppression quality foam for fire protection.

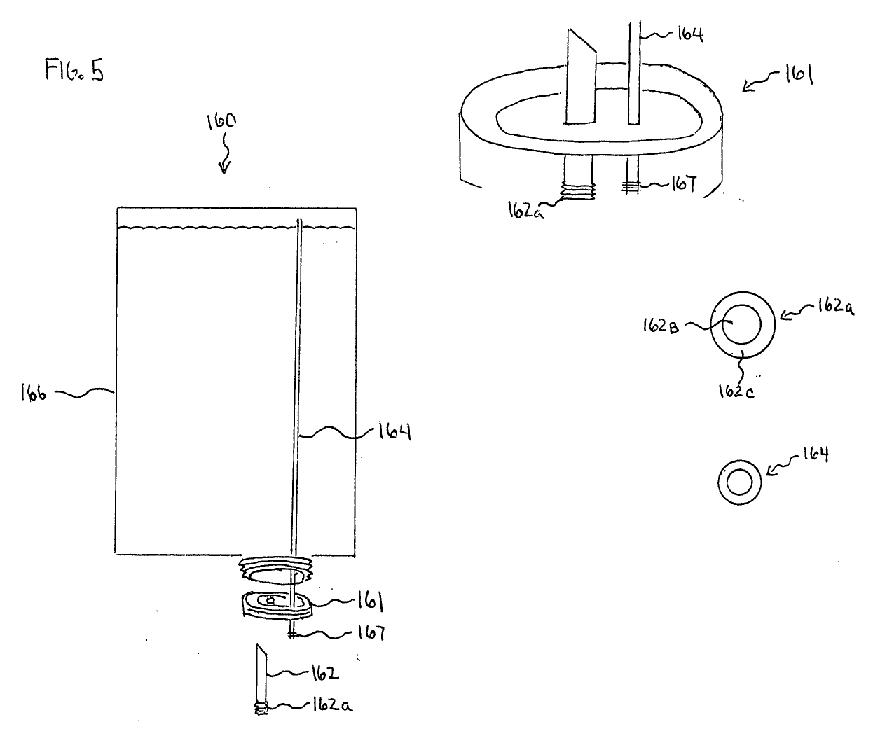

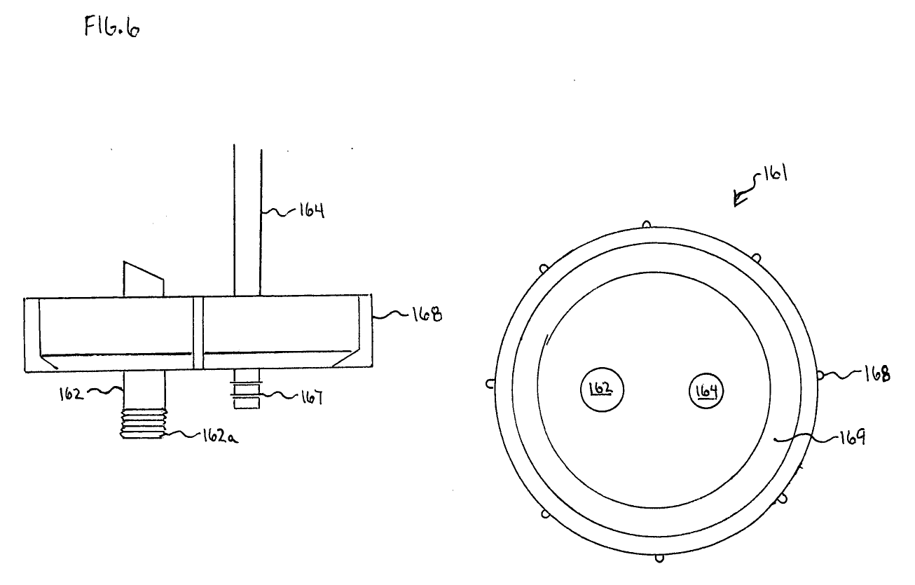

As FIG. 5, illustrates, the vacuum dispensing closure 161 with threaded dispensing nipple 162a that receives a metering valve (not shown) preset to allow flow of a pre-determined rate of foam concentrate from tight head pail 166 in proportion to the gallons per minute being drawn from water supply line 72 FIG. 1 once air operated pump 80 is activated. The vacuum dispensing closure vent 164 is designed to allow a continuous stream to be drawn from the threaded vacuum dispensing closure nipple 162a and prevent tight head pail 166 walls from collapsing under vacuum pressure created at vacuum blending console tee 70. The exposed first end of vent 164 is barbed 167 to attach a tygon extension hose to control panel 20 where it is attached to a shutoff valve (not shown) to prevent contamination/insects from clogging vent tube 67 to atmosphere. The second end of vent 164 is above the fluid level in the inverted tight head pail allowing for vent to atmosphere. This design is such because the system may not be used and perforating the tight head pails body 166 to atmosphere would oxidize the foam concentrate and reduce its shelf life of two years. FIG. 6 illustrates a perspective view of the design inside the vacuum dispensing closure 161 as well as a side view. The outside diameter of the closure has merlons 168 for gripping when tightening or loosening the closure. A gasket 169 of a pvc type membrane to ensure a leak tight seal. The relationship of the dispensing nipple 162 and vent 164 to the overall architecture are demonstrated and will be manufactured so as to be an integral part to the closure body 161. The closure 161 in its entirety will be made of high-density polyethylene with industry standard buttress type threads 163 FIG. 4 for joining with tight head pail.

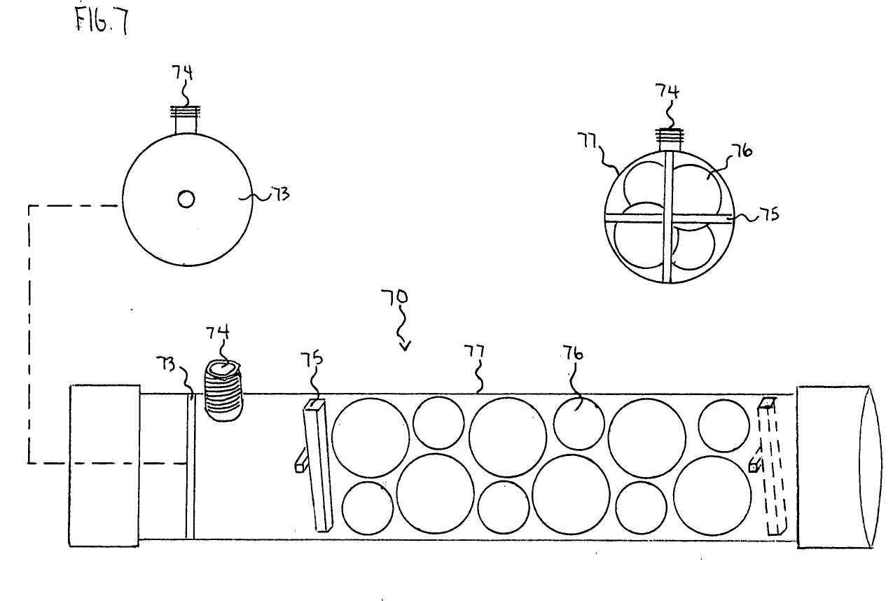

For the user of this self-sustaining compressed air foam system simplicity is required when needed to produce structure protection quality pre-suppression foam. Panic could lead to misuse if a user needs to think of what ratio of foam concentrate to water is needed with an approaching wildfire. Therefore all components are engineered to deliver a specific ratio of foam concentrate to water that will produce a consistent pre-suppression quality foam. Foam concentrate manufacturers recommend a ratio of concentrate to water to be in the range of greater than 0.5% to less than or equal to 1% FIG. 7 illustrates a perspective view of the vacuum-proportioner/blender console 70, 70a made of plastic or metal, tubing or pipe, it eliminates the need for thinking about ratios. Said console is pre-engineered to deliver the correct proportion (proprietary ratio) of foam concentrate to water and is part of the water/foam concentrate solution feed line 72,74 and depicts one of several designs consisting of a body 77 with a first end having a constrictive plate 73 designed to reduce the water flow to a specific rate from the water tank 50 to the pump 80,120 wherein said constrictive plate 73 is proceeded by a void with an inlet port 74 directly above and adjacent to the constrictive plate 73 to create a vacuum that draws foam concentrate via tube 62,64 into the water stream for blending through the spheres 76 that are contained in situ by impediments 75. The threaded second end attaches directly to the upstream side of a pump 80, 120 to channel the water/foam concentrate solution to the next component in the process.

The final component in the process to produce a pre-suppression quality foam product is depicted in FIG. 8. The air-insertion agitator 123, 123a that consists of a plastic or metal pipe or tube that's threaded on both ends with the first end having an air-insertion port 124 to receive pressurized air from line 24,24a that agitates and expands the foam solution as it passes through a static-mixer 125 that produces the finished foam product. That static-mixer is an off-the-shelf item produced by several manufacturers and is held in place by impediment 126 and exits second end to proceed via hose or pipe in an expanded foam state to an applicator or nozzle 90.

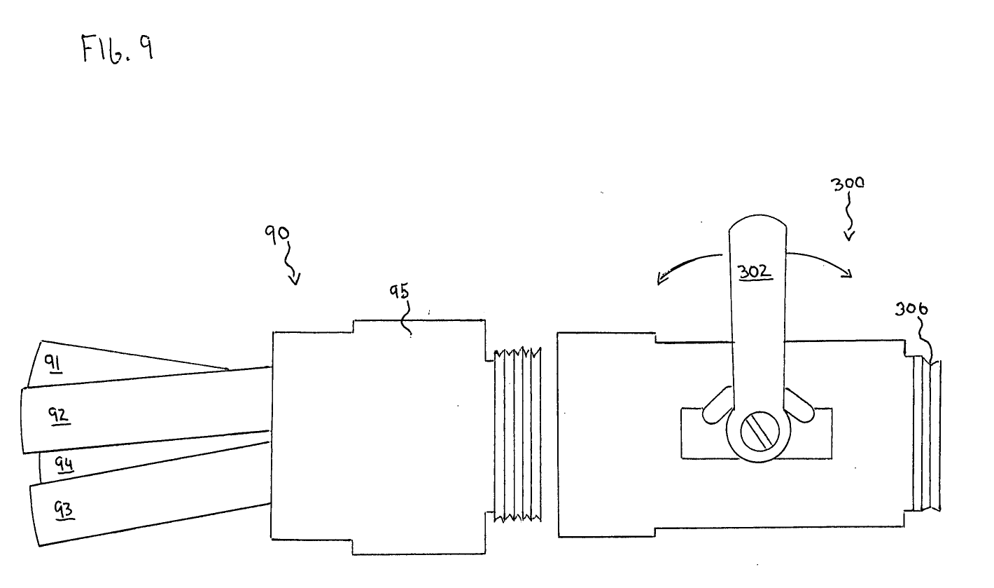

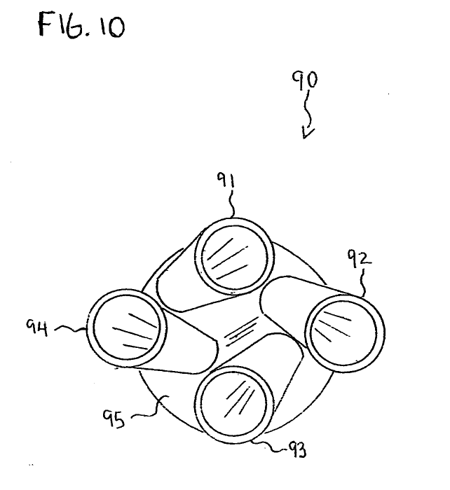

Pressure Reducing Applicator: The design of the pressure-reducing-applicator 90, FIGS. 9,10 eliminates the need for the user of this system to manually reduce the working pressure when applying foam in confined areas (heat traps) such as under decks or in and around carports or where applying foam in close proximity to fuels or structures and the potential for over application and fluff off of foam blanket is possible. The pressure-reducing applicator attaches to a standard inline shutoff adapter 300 for standard firefighting hose. The inline shutoff adapter 300 serves as a nozzle for the system when applying pre-suppression foam to broad areas 50 to 75 feet away such as roofs or in the canopy of trees. When close-up foam application work is required the user simply attaches the pressure-reducing-applicator 90 by hand after shutting down the flow of foam with the lever 302 on the inline shutoff adapter 300. No tool is required and to re-activate the foam stream simply pull the lever handle 302 back on the inline shutoff adapter 300.

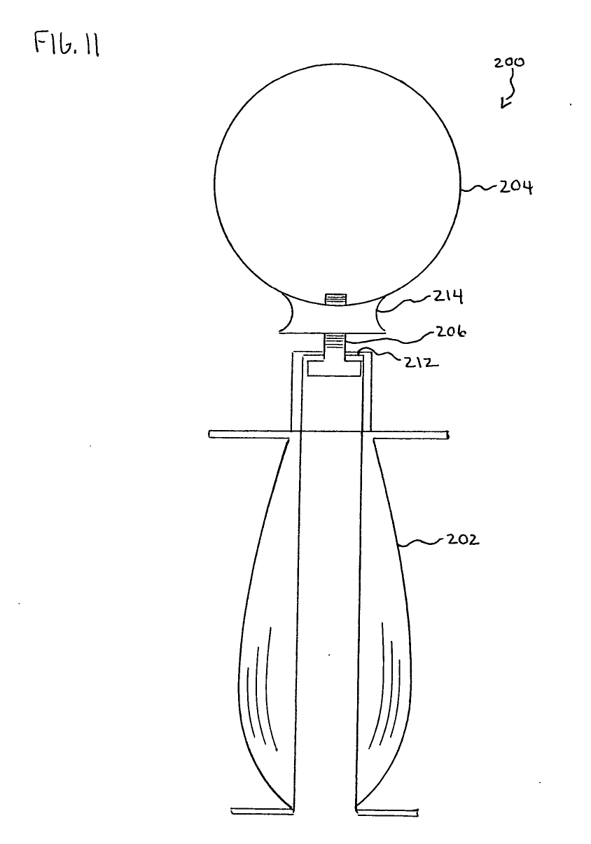

This set-up is un-wieldy without the use of a handle or grip. FIG. 11 illustrates a detachable grip 200. Expensive pistol grip type nozzles designed for professional firefighters offer little for a homeowner seeking a specific bubble structure in finished foam. Open bore type nozzles are the preferred method and with the detachable grip 200 greater control and comfort are accomplished. The handle 202 of the grip 200 allows the bolt 206 to be attached to the base nut 214 of the retainer ring 204 that surrounds the outside diameter of the inline shutoff adapter 300 just behind the shutoff lever 302 at point 306. Turning the handle 202 counterclockwise will extract the bolt to a point that allows the retainer to be place around the body of the inline shutoff adapter 300 and to secure the grip 200 simply turn the handle clockwise to tighten the bolt that contacts the body of the inline shutoff adapter 300 causing the retainer ring 204 to secure the assembly. This inexpensive grip is placed into position prior to activating the system. The removable grip 200 can be made of plastic or metal or both but, must be capable of withstanding operating forces of the application, over torquing the handle 202 could cause failure at the shoulder/stop 212 therefore the handle 202 will be made of a durable high impact polycarbonate/acrylonitrile butadiene styrene while the retainer ring 204 will be made of a more flexible polypropylene or aluminum. The bolt 206 will be of steel with a hardness greater than the inline shutoff adapter 300 which is aluminum allowing the steel bolt or stud to seat itself in the aluminum body of the adapter.

In summary, the present self-sustaining compressed air foam system makes use of a tight head pail to supply foam concentrate to a vacuum-proportioning-blender attached to a water source and choice of stored energy operated pump(s) that draw water and foam concentrate as a solution to exit the pump(s) where a pressurized inert gas insertion port is attached to set in motion the foam solution through an agitator that expands the foam solution to exit a nozzle as a finished pre-suppression quality foam for the protection of structures in the event of an approaching wildfire.

While I have shown certain embodiments of the present invention, it is to be understood that it is subject to many modifications and changes without departing from the spirit and scope of the appended claims.

I claim:

1. A self-sustaining compressed air foam system comprising:
A source of stored energy;
A source of liquids adapted to produce foam;
A pump capable of communicating with the source of stored energy to drive the pump and a liquid inlet and liquid discharge to discharge said liquids from the pump;
A vacuum-dispensing-closure for tight head pails to dispense a liquid adapted to produce a foam solution when mixed with water.
A vacuum-proportioning-blender console to deliver proportionate amounts of two or more liquids adapted to produce a foam solution in ratios from 0.1 to 6% of foam concentrate when blended with water;
A second stage blender/mixer/agitator, with injection port for compressed air or other inert gas such as nitrogen attached to the discharge side of said pump to produce the finished foam product.
A nozzle with a threaded beginning transitioning to a chamber greater than the diameter of the threaded beginning of said nozzle and transitioning to a multi-ported end that may have but is not limited to two or more exit ports that are less than the diameter of the threaded beginning and said exit ports will diverge from one another to create a specific foam application pattern.

2. The system of claim 1 wherein said vacuum-dispensing-closure for tight head pails containing a liquid adapted to produce a foam; a cap threaded to adapt to a tight head pail and ported with one or more ports to dispense said liquid to a vacuum-proportioning-blender console attached to the inlet of a pump and also vented to atmosphere preventing tight head pail collapsing under negative pressure.

3. The system of claim 2 wherein said vacuum-dispensing-closure for tight head pails is attached via a tube, hose or pipe to a vacuum-proportioning-blender attached or fastened by means of threads, a weld or flange to the inlet of a pump to draw proportional amounts of liquids adapted to produce a foam solution.

4. The system of claim 3 wherein said vacuum-proportioning-blender console being attached to the inlet of a pump and having a plastic or metal body and not limited to a threaded beginning and end with a tee branch having an engineered orifice to draw a specific percentage of liquid adapted to produce a foam solution from the vacuum-dispensing closure for tight head pails. Wherein the run of the body of said vacuum-proportioning-blender console is a constrictive plate upstream of the tee branch and a blending tool through which a known amount of water passes to blend through with said liquid adapted to produce a foam solution.

5. The system of claim 4 wherein said vacuum-proportioning-blender console is attached to the inlet of a pump;
A pump wherein a second stage blender/mixer/agitator in the form of a threaded tube or pipe and is attached to the discharge side of said pump and having a beginning and an end to which an injection port is positioned at the beginning wherein compressed air or an inert gas is injected to create an explosive blending through a mixing element to finish the foam product.
